(19) United States
(12) Patent Application Publication
(10) Pub. No.: US 2016/0080205 A1
(43) Pub. Date: Mar. 17, 2016

(54) Plug and Play Camera Configuration Tool for Internet Protocol Cameras with Export to Third-Party Video Management Software Support, Batch Firmware Update, and Other Capabilities

(71) Applicants: Anthony L. Brown, Tinley Park, IL (US); Thomas C. Carnevale, Plainfield, IL (US)

(72) Inventors: Anthony L. Brown, Tinley Park, IL (US); Thomas C. Carnevale, Plainfield, IL (US)

(73) Assignee: Sentry360, Plainfield, IL (US)

(21) Appl. No.: 14/596,474

(22) Filed: Jan. 14, 2015

Related U.S. Application Data
(60) Provisional application No. 62/051,201, filed on Sep. 16, 2014.

(51) Int. Cl. H04L 12/24; H04L 29/08; H04L 29/06; H04N 5/232

(52) U.S. Cl. CPC H04L 41/0853; H04L 41/0866; H04N 5/23206; H04N 5/23216; H04N 5/23293; H04L 67/24; H04L 69/08; H04N 5/23225

(57) ABSTRACT

A camera configuration tool that facilitates a method for configuring and managing Internet Protocol (IP) cameras across a network. A software program scans a network to discover a plurality of IP cameras, wherein camera data for each of the plurality of IP cameras is retrieved and added to a camera table as a camera item that is selectable. Through a graphical user interface, a user can then manage and configure the plurality of IP cameras. A web interface access request, restart request, live feed request, and reset request can be sent to a specific camera from the plurality of IP cameras through the graphical user interface in addition to adjusting image settings and transmission settings, and uploading a firmware file to the specific camera. The camera data for the plurality of IP cameras can also be exported to a video management software, spreadsheet file, or text file.

The current application claims a priority to the U.S. Provisional Patent application Ser. No. 62/051,201 filed on Sep. 16, 2014.

### FIELD OF THE INVENTION

The present invention relates generally to Internet Protocol (IP) camera management. More specifically, the present invention is a software-based, plug-and-play configuration tool for IP cameras that allows a user to quickly configure a plurality of IP cameras simultaneously, in a matter of minutes, as opposed to manually configuring each camera separately via a web browser.

### BACKGROUND OF THE INVENTION

Presently, conventional Internet Protocol (IP) camera configuration can be a hassle for the individual performing the installation and setup. An IP camera, is a type of digital video camera commonly employed for surveillance. Unlike analog closed circuit television (CCTV) cameras, IP cameras can send and receive data via a computer network and the Internet. Although most cameras that do this are webcams, the term “IP camera” or “netcam” is usually applied only to those used for surveillance.

Setup of IP cameras for a surveillance network is generally a cumbersome, repetitive, and tedious task. This is because the user must access the cameras individually via a web browser and configure each of them one-by-one. Every IP surveillance camera has an IP address, which can be accessed through the web browser and displays the camera's main interface. Here, all of the camera's settings are found, including firmware version, image, bandwidth, frame rate, brightness, contrast, saturation, among many other settings. After the user performing the installation physically connects all of the cameras to the network, the user usually must log into each camera web page separately, adjust settings in the browser, close the browser, and continue this process for each camera. It is therefore an objective of the present invention to introduce a software system to streamline the management of IP cameras and allow for the configuration of multiple cameras at once, while alleviating other related problems.

The present invention allows the user to configure all of the cameras via a single interface, wherein the user can enter and save settings without having to open a separate web page for each camera. From this point, the installer must open the video management software (VMS) separately and add the cameras to the VMS. The process of adding cameras to the VMS is streamlined by exporting all discovered and selected cameras on the network into the VMS through the single interface of the present invention.

### SUMMARY OF THE INVENTION

The present invention is a plug-and-play camera configuration tool for Internet Protocol (IP) cameras implemented through a software program. In the preferred embodiment of the present invention, the software program can configure up to two hundred fifty cameras in less than five minutes, by simultaneously managing the IP address and network settings for each camera. In other embodiments, the number of cameras may be increased, and the configuration time may vary.

The IP address of each camera can be configured manually or automatically based on the scheme(s) of available network interface cards and free IP addresses. The invention is not a video management software (VMS), but instead a configuration tool that can save the user time. With the present invention, camera installation and configuration takes only several minutes to an hour depending on the complexity of configuration and the number of cameras to be set-up. Overall, by using the present invention, the entire camera configuration and management process is streamlined.

### BRIEF DESCRIPTION OF THE DRAWINGS

FIG. 1 is a flowchart depicting the steps for scanning a network in order to discover and manage a plurality of Internet Protocol (IP) cameras;

FIG. 2 is a flowchart thereof, depicting steps for switching between a first communication protocol and a second communication protocol in order to communicate with the plurality of IP cameras;

FIG. 3 is a flowchart thereof, depicting steps for accessing a web interface for a specific camera from the plurality of IP cameras;

FIG. 4 is a flowchart thereof, depicting steps for sending a restart command to the specific camera;

FIG. 5 is a flowchart thereof, depicting steps for uploading a firmware file to the specific camera;

FIG. 6 is a flowchart thereof, depicting steps for exporting camera data for the specific camera to a video management software (VMS);

FIG. 7 is a flowchart thereof, depicting steps for organizing the camera data of each of the plurality of IP cameras in a camera table;

FIG. 8 is a flowchart thereof, depicting steps for exporting the camera data for the plurality of IP cameras to a spreadsheet file or a text file;

FIG. 9 is a flowchart thereof, depicting steps for displaying a live feed stream of the specific camera or of a subsequent camera through a second graphical user interface;

FIG. 10 is a flowchart thereof, depicting steps for utilizing a graphical indicator with the second graphical user interface in order to indicate detected motion;

FIG. 11 is a flowchart thereof, depicting steps for reporting and recording motion detection data; and

FIG. 12 is a flowchart thereof, depicting steps for resetting the specific camera to factory default settings.

FIG. 13 is a diagram depicting a graphical user interface for displaying the camera table which contains camera data for the plurality of IP cameras.

FIG. 14 is a diagram depicting initiation of a firmware file selection through a menu accessible by right-clicking on a camera item for the specific camera in the camera table.

FIG. 15 is a diagram depicting initiation of launching a web page for the specific camera through the menu accessible by right-clicking on the camera item for the specific camera.

FIG. 16 is a diagram depicting the second graphical user interface used to display the live feed stream of the specific camera.

FIG. 17 is a diagram depicting initiation of a restart request through the menu accessible by right-clicking on the camera item for the specific camera.

FIG. 18 is a diagram depicting confirmation of the restart request for the specific camera.

FIG. 19 is a diagram depicting a window for adjusting transmission settings for the specific camera.

FIG. 20 is a diagram depicting confirmation of adjustments to the transmission settings for the specific camera.

FIG. 21 is a diagram depicting the selection of a series of IP cameras to be exported to the VMS selected by a user.

FIG. 22 is a diagram depicting controls for adjusting image settings of the plurality of IP cameras through the graphical user interface.

FIG. 23 is a diagram depicting controls for adjusting motion detection settings for the specific camera.

### DETAIL DESCRIPTIONS OF THE INVENTION

All illustrations of the drawings are for the purpose of describing selected versions of the present invention and are not intended to limit the scope of the present invention.

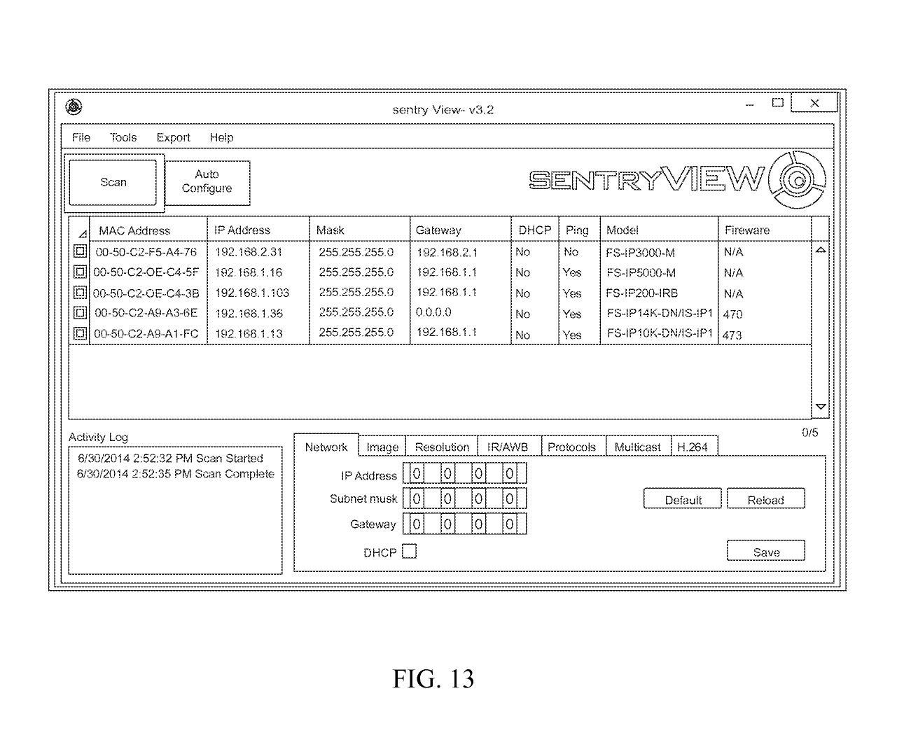

The present invention is a camera configuration tool that facilitates a method for configuring and managing Internet Protocol (IP) cameras across a network 1. The present invention is implemented as a software program 2 on a host device, such as a server or desktop, that is connected to the network 1. In reference to FIG. 13, the software program 2 provides a graphical user interface 20 through which a user can interact with the software program 2 in order to command a plurality of IP cameras 3 across the network 1. It is also possible for a different type of user interface to be used in place of or in conjunction with the graphical user interface 20.

The method for configuring and managing IP cameras provides a means for initiating several sub-processes that are used to control the plurality of IP cameras 3 across the network 1. The sub-processes carried out by the present invention can be programmed in a variety of ways in order to achieve the same functionality. As such, the sub-processes of the present invention are not limited in the exact algorithmic implementations but rather in the overall functionality provided by each of the sub-processes.

The method for configuring and managing IP cameras includes the sub-processes for startup, network 1 scanning, camera timeout detection, communication protocol switching, launching a camera browser web interface, remote restarting, batch broadcast firmware uploads, exporting cameras to third-party video management software (VMS), exporting cameras to a spreadsheet application, exporting cameras to a text file 82, previewing a camera feed, controlling camera image settings 70, broadcast bandwidth management, calibrating camera image, calibrating camera motion detection, and returning cameras to default settings.

In order to use the camera configuration tool, the user must first startup the software program 2, wherein the user is presented with the graphical user interface 20. In reference to FIG. 13, the graphical computer interface displays a camera table 21 having a plurality of rows 210 and a plurality of columns 212 for sorting and displaying camera data 30 from each of the plurality of IP cameras 3. Each of the plurality of rows 210 is designated for a specific camera 31 from the plurality of IP cameras 3, while each of the plurality of columns 212 contains camera data 30 for the specific camera 31. In the preferred embodiment of the present invention, the plurality of columns 212 is divided into the following fields: media access control (MAC) address, IP address, mask, gateway, Dynamic Host Configuration Protocol (DHCP), ping, model, firmware. Other embodiments of the present invention may employ additional fields or fewer fields depending on the needs of the user.

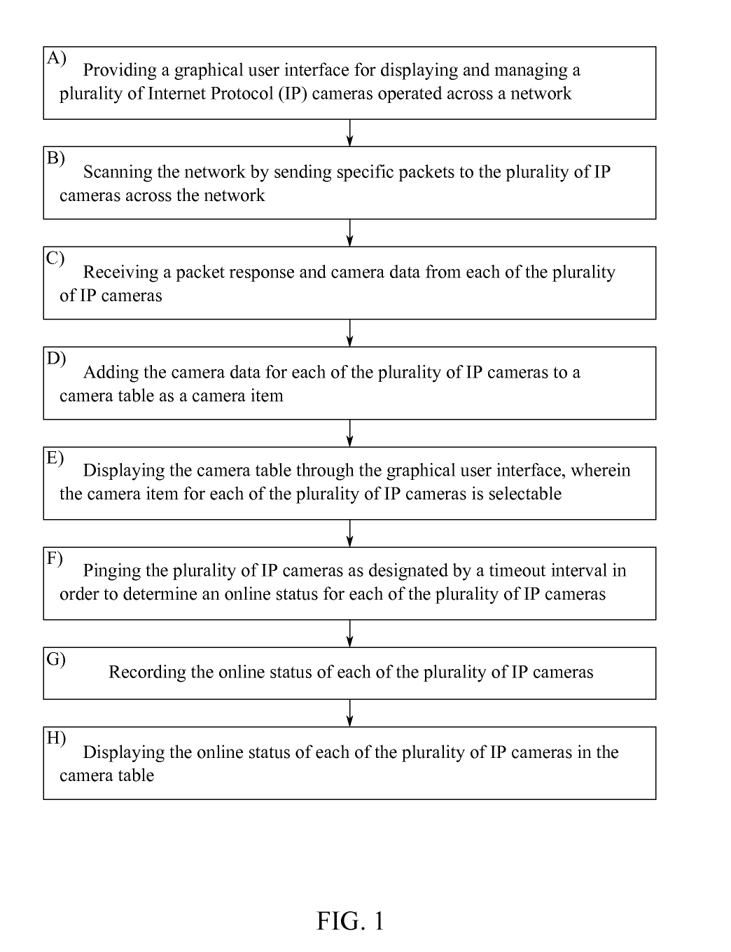

In reference to FIG. 1, to begin controlling and managing the plurality of IP cameras 3, the software program 2 must scan the network 1 in order to discover and establish communication with the plurality of IP cameras 3. The network 1 scanning is initiated by the user through the graphical user interface 20. Once the network 1 scanning is initiated by the user, the software program 2 scans the available network 1 interface card for each of the plurality of IP cameras 3 by sending out specific packets 40 across the network 1 through the host device. When a camera recognizes the specific packets 40, the camera sends a packet response 41 and camera data 30 back to the host device. The packet response 41 and the camera data 30 are then received by the software program 2, wherein the camera data 30 is organized into a camera item 22 that is displayed in the camera table 21. For each of the plurality of IP cameras 3 discovered by the software program 2, a new row is added to the plurality of rows 210 of the camera table 21 containing the camera data 30 in the plurality of columns 212.

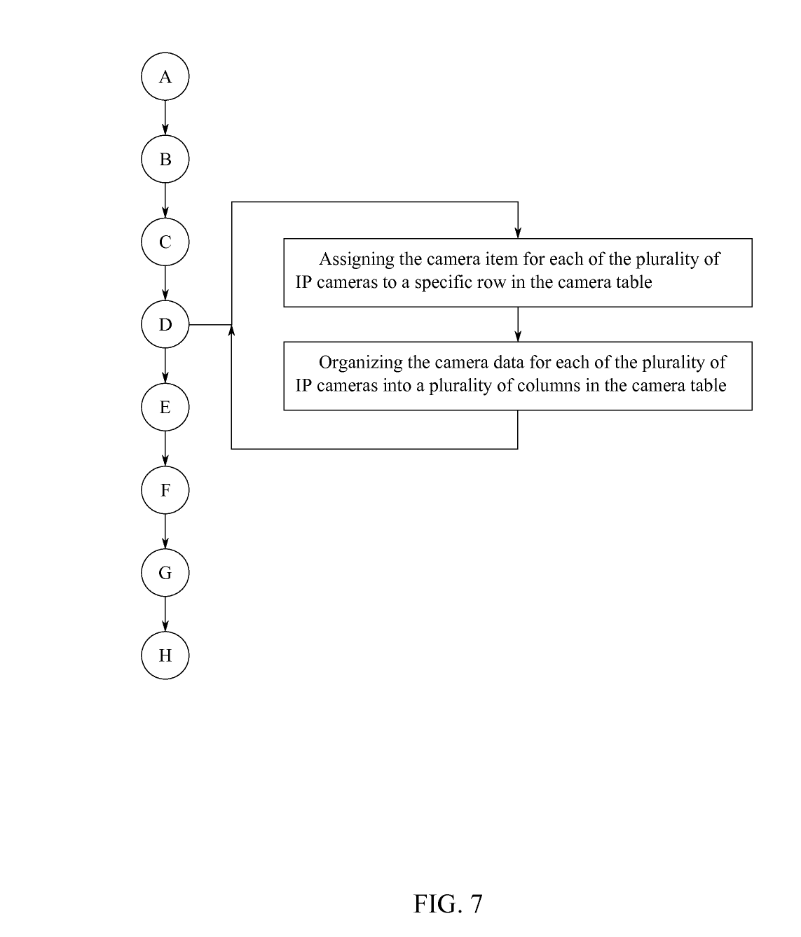

In reference to FIG. 7, the software program 2 receives the packet response 41 and the camera data 30 from each of the plurality of IP cameras 3, wherein the camera data 30 for each of the plurality of IP cameras 3 is added to the camera table 21. The camera item 22 for each of the plurality of IP cameras 3 is assigned to a specific row 211 from the plurality of rows 210 in the camera table 21. The plurality of rows 210 may be arranged in any order to display the plurality of IP cameras 3. For example the camera item 22 for each of the plurality of IP cameras 3 can be added to the camera table 21 successively as each of the plurality of IP cameras 3 is discovered on the network 1, or the plurality of IP cameras 3 can be organized by model, manufacturer, etc. The camera data 30 for the camera item 22 of each of the plurality of IP cameras 3 is organized into the plurality of columns 212 of the camera table 21. The camera data 30 (such as the MAC address, IP address, mask, gateway, DHCP, or model) is organized into the appropriate column for each of the plurality of IP cameras 3, wherein the camera data 30 for each of the plurality of IP cameras 3 is systematically displayed within the camera table 21.

Once the network 1 scanning process is completed, each of the plurality of IP cameras 3 discovered by the software program 2 is displayed in the camera table 21 to the user through the graphical user interface 20, as depicted in FIG. 13. The plurality of IP cameras 3 is displayed in the camera table 21, wherein the camera item 22 for each of the plurality of IP cameras 3 is selectable. The user can then select a specific camera 31 from the plurality of IP cameras 3 to configure, control, manage, etc. Alternatively, the user can select a group of cameras from the plurality of IP cameras 3 to configure, control, manage, etc. at the same time, thus saving the user a considerable amount of time. The following describes the sub-processes that can be carried out for a single camera or for multiple cameras.

In reference to FIG. 1, the camera timeout detection sub-process monitors whether or not a camera has gone offline. An online status 43 is designated and displayed for each of the plurality of IP cameras 3 in the camera table 21. The software program 2 constantly pings the plurality of IP cameras 3 discovered on the network 1 by sending a signal from the host device. If a camera sends a response back to the host device, then the online status 43 for the camera is designated as online. Conversely, if the software program 2 does not detect a response back from a camera, then the online status 43 for the camera is designated as offline. The online status 43 for each of the plurality of IP cameras 3 is recorded by the software program 2 and then displayed in the camera table 21.

In the preferred embodiment of the present invention, the online status 43 being online is designated with a “Yes” displayed in the camera table 21, while the online status 43 being offline is designated in the camera table 21 with a “No”, as depicted in FIG. 13. It is also possible for any other combination or type of indicators to be used to depict the online status 43, such as a green dot and red dot, check mark and ‘x’ mark, etc. The display of the online status 43 for each of the plurality of IP cameras 3 in the camera table 21 allows the user to have one central window with an easy-to-understand interface to find if a camera happens to go offline, or to view if the user has restarted a camera and is waiting for the camera to come back online again.

In reference to FIG. 1, the software program 2 sends a ping to each of the plurality of IP cameras 3 that has been discovered on the network 1 according to a timeout interval 42. The user is able to set the timeout interval 42 in seconds, wherein the software program 2 pings the plurality of IP cameras 3 every set number of seconds. For example, in the preferred embodiment of the present invention, the timeout interval 42 is set to twenty seconds, wherein every twenty second the software program 2 pings the plurality of IP cameras 3 to check the online status 43 of each of the plurality of IP cameras 3.

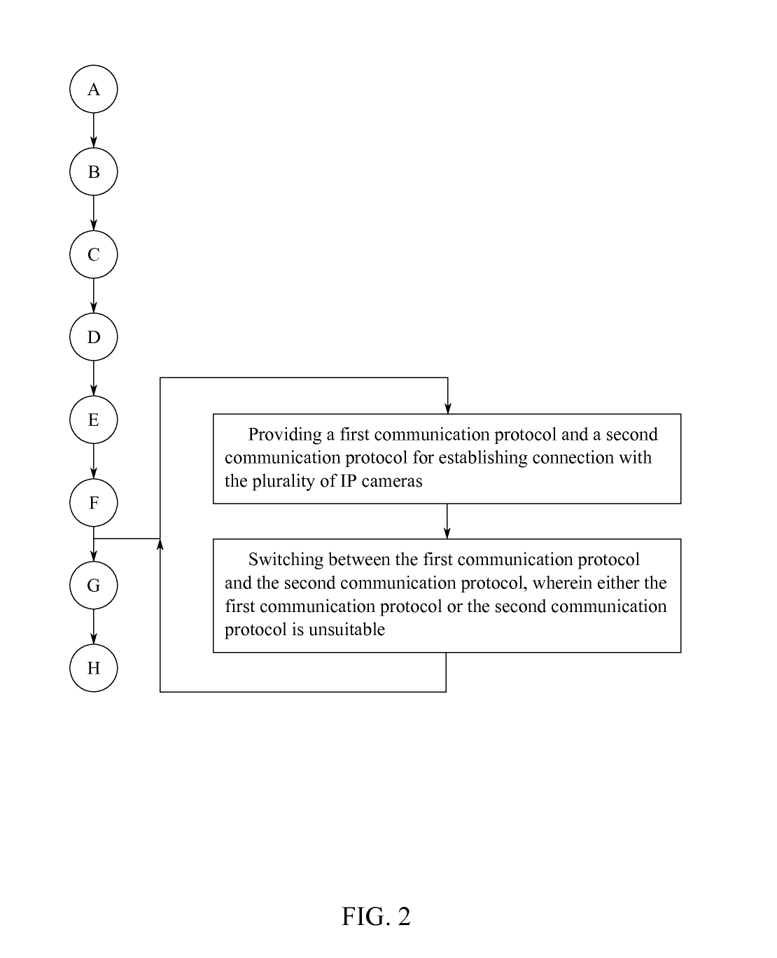

In reference to FIG. 2, through the communication protocol switching sub-process, the user can change the communication protocol that the software program 2 uses to communicate with the plurality of IP cameras 3 through the host device. A first communication protocol 10 and a second communication protocol 11 are provided, between which the software program 2 can switch in order to send Common Gateway Interface (CGI) commands to the plurality of IP cameras 3. The present invention allows the user to switch between the first communication protocol 10 and the second communication protocol 11 in case there are any network 1 issues where either the first communication protocol 10 or the second communication protocol 11 will not work correctly. It is also possible for more than two communication protocols to be utilized. The communication protocol can be switched by the user through the graphical user interface 20, which allows the user to readily switch between communication protocols for quick recovery in the event of network 1 trouble.

In the preferred embodiment of the present invention, the first communication protocol 10 is Trivial File Transfer Protocol (TFTP) and the second communication protocol 11 is Hypertext Transfer Protocol (HTTP). In this way, CGI commands can be sent to the plurality of IP cameras 3 using either TFTP or HTTP depending on the network 1 stability or preference of the user. Being able to switch between two communication types can save several minutes. Rather than having to avoid troubleshooting if the network 1 might be blocking one communication method based on the network 1 setup, the user can simply switch to the alternative communication method.

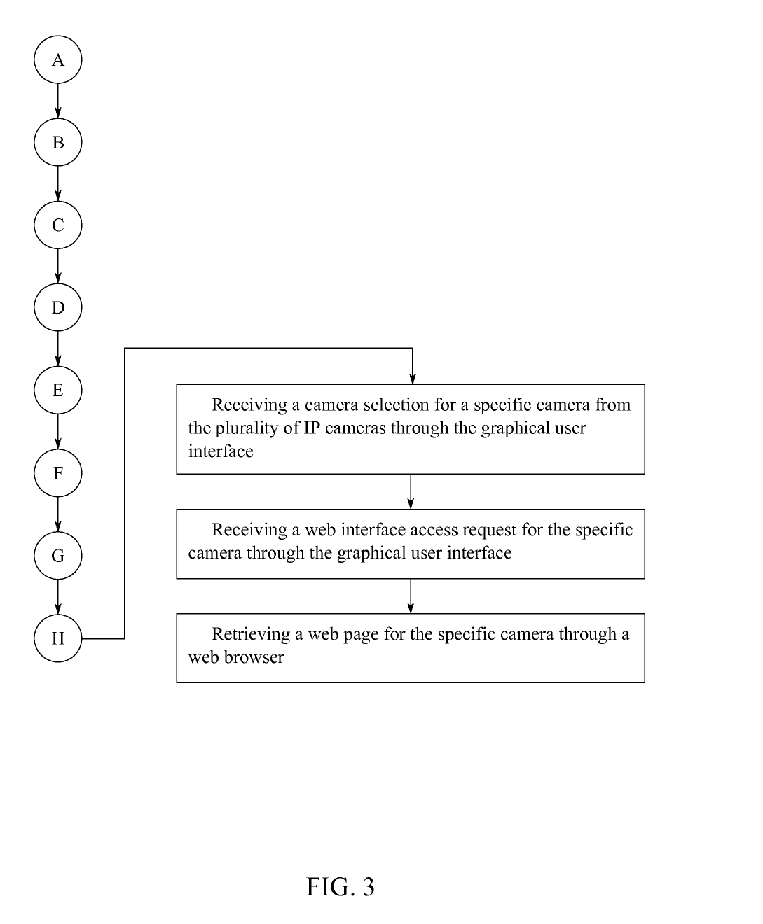

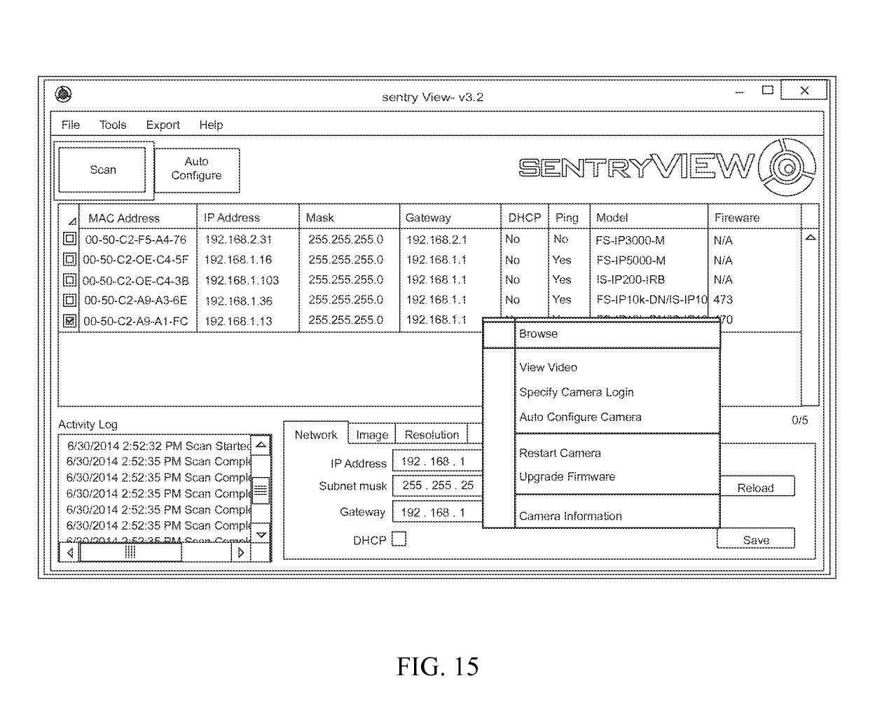

The camera browser web interface launching sub-process is a user-friendly menu shortcut. Each of the plurality of IP cameras 3 on the network 1 has a web interface that can be accessed by entering the IP address in a web browser 91. To expedite the process of entering the IP address into the web browser 91 for each of the plurality of IP cameras 3, the present invention allows the user to make a web interface access request 92 for a specific camera 31 from the plurality of cameras through the graphical user interface 20, as depicted in FIG. 15. In reference to FIG. 3, the user first makes a camera selection 23 for the specific camera 31 through the graphical user interface 20, and then makes the web interface access request 92 for the specific camera 31. Upon receiving the camera selection 23 and the web interface access request 92 for the specific camera 31, the software program 2 retrieves a web page 90 for the specific camera 31 through the web browser 91, wherein the user can then view a live feed stream 26 of the specific camera 31 through the web page 90.

In the preferred embodiment of the present invention, the camera selection 23 is made by right-clicking on the camera item 22 in the camera table 21 for the specific camera 31, as depicted in FIG. 15. A menu for the specific camera 31 is then opened and displayed through the graphical user interface 20. The user can then select the “browse” option, which initiates the web interface access request 92 that in turn launches the web browser 91 with the IP address for the specific camera 31 preloaded into the address bar of the web browser 91. As a result the web page 90 for the specific camera 31 is automatically retrieved by the web browser 91. This takes the user no more than five seconds, compared to manually opening the web browser 91, typing the IP address in the address bar, and submitting the IP address. It is also possible for the web interface access request 92 to be initiated through the main menu or sub-menus of the software program 2.

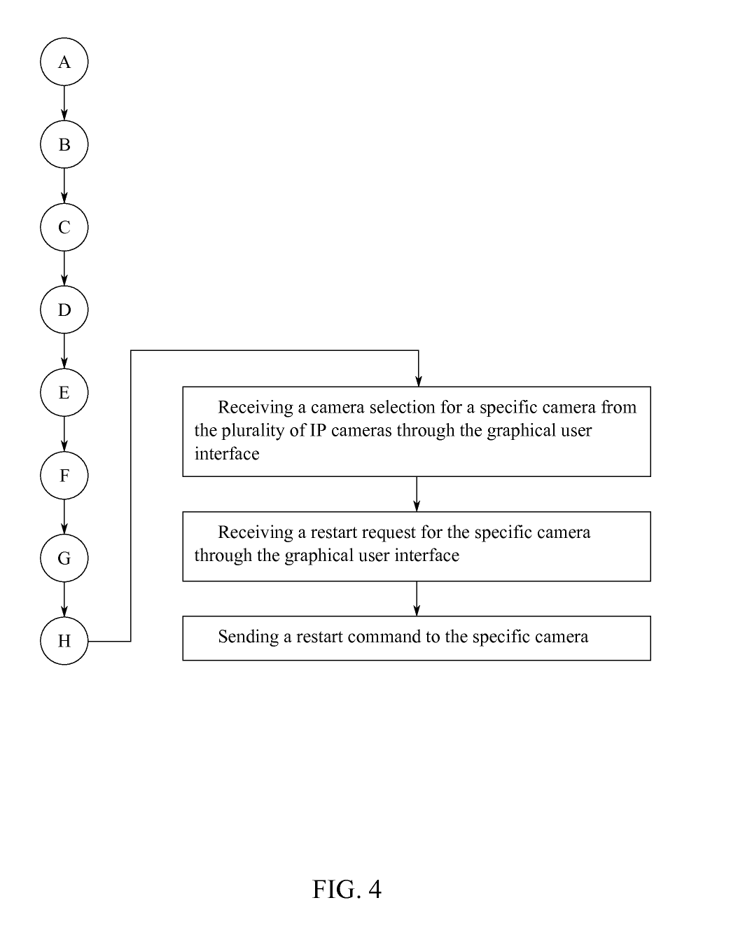

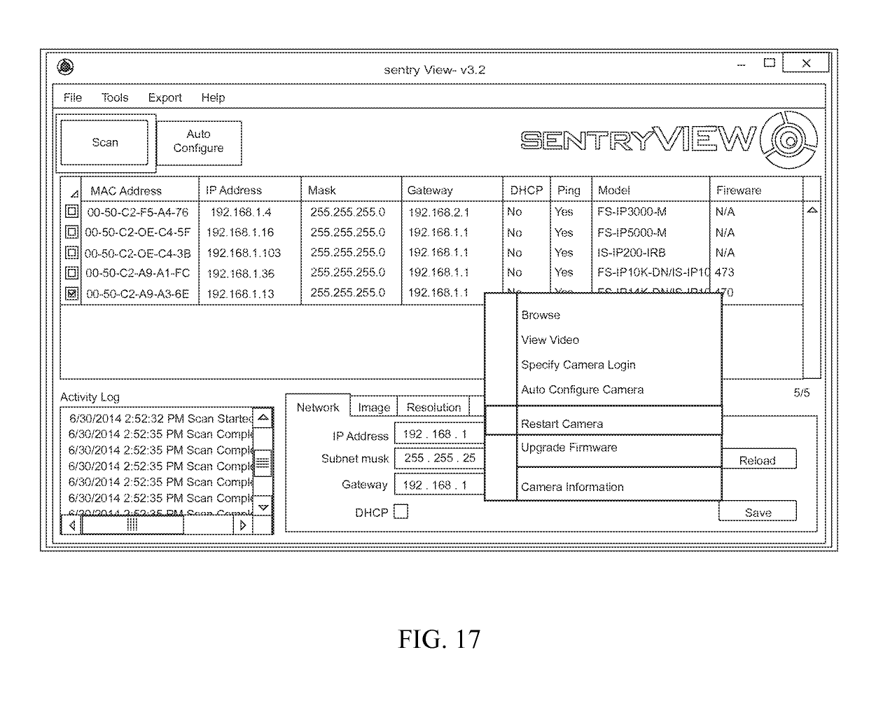

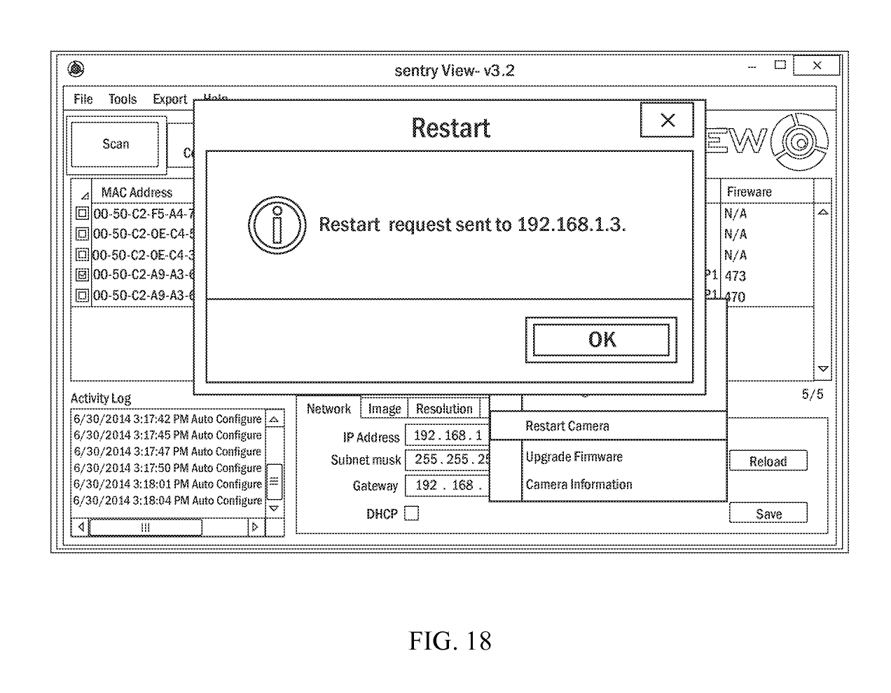

The remote restarting sub-process allows the user to restart each of the plurality of IP cameras 3 as needed. In reference to FIG. 4, to restart a specific camera 31 from the plurality of IP cameras 3, the user first makes a camera selection 23 for the specific camera 31 through the graphical user interface 20, as depicted in FIG. 17. The user then makes a restart request 50 for the specific camera 31. Upon receiving the camera selection 23 and the restart request 50 for the specific camera 31, the software program 2 sends a restart command 51 to the specific camera 31 using the specified communication protocol (e.g. TFTP or HTTP) and displays a restart confirmation to the user as depicted in FIG. 18. If the restart command 51 is successfully sent and successfully received by the specific camera 31, then the specific camera 31 will turn off and the online status 43 for the specific camera 31 will be designated as offline in the camera table 21. Upon turning on again, the specific camera 31 will respond the next time the software program 2 pings the plurality of IP cameras 3, wherein the online status 43 for the specific camera 31 will be designated as online in the camera table 21.

In the preferred embodiment of the present invention, the camera selection 23 is made by right-clicking on the camera item 22 in the camera table 21 for the specific camera 31, as depicted in FIG. 17. A menu for the specific camera 31 is then opened and displayed through the graphical user interface 20. The user can then select the “restart” option, which initiates the restart request 50 that in turn sends the restart command 51 to the specific camera 31. As a result a restart confirmation is displayed through the graphical user interface as shown in FIG. 18, and the online status 43 for the specific camera 31 is set to “No” in the camera table 21. When the specific camera 31 turns on again, the online status 43 for the specific camera 31 is set to “Yes” in the camera table 21. It is also possible for the restart request 50 to be initiated through the main menu or sub-menus of the software program 2.

The ability to restart the plurality of IP cameras 3 through the graphical user interface 20 allows the user to avoid either having to navigate into the web interface to find the correct button to restart the specific camera 31, or having to physically unplug the specific camera 31 from the network 1. As a result, the remote restarting sub-process can save the user several seconds up to several minutes. In regards to saving several minutes, this refers to situations where the only option is to temporarily disconnect a camera by unplugging it from the switch, which may not always be easily accessible from the current location of the user. Instead, the remote restarting sub-process takes twenty to thirty seconds for a camera to power down, reboot, and appear back online.

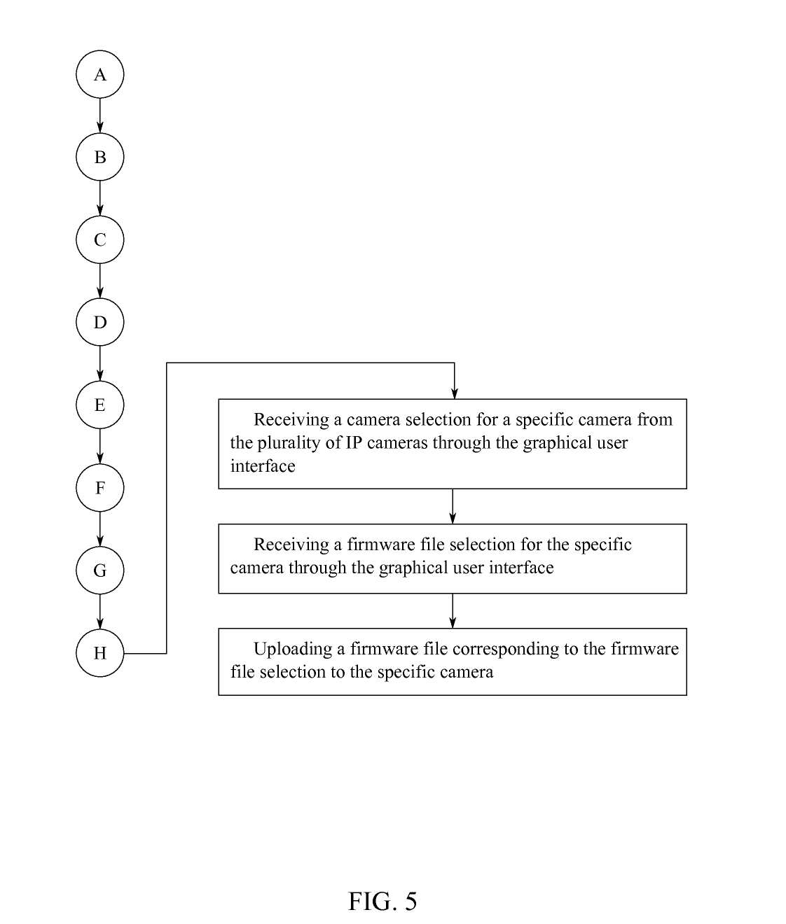

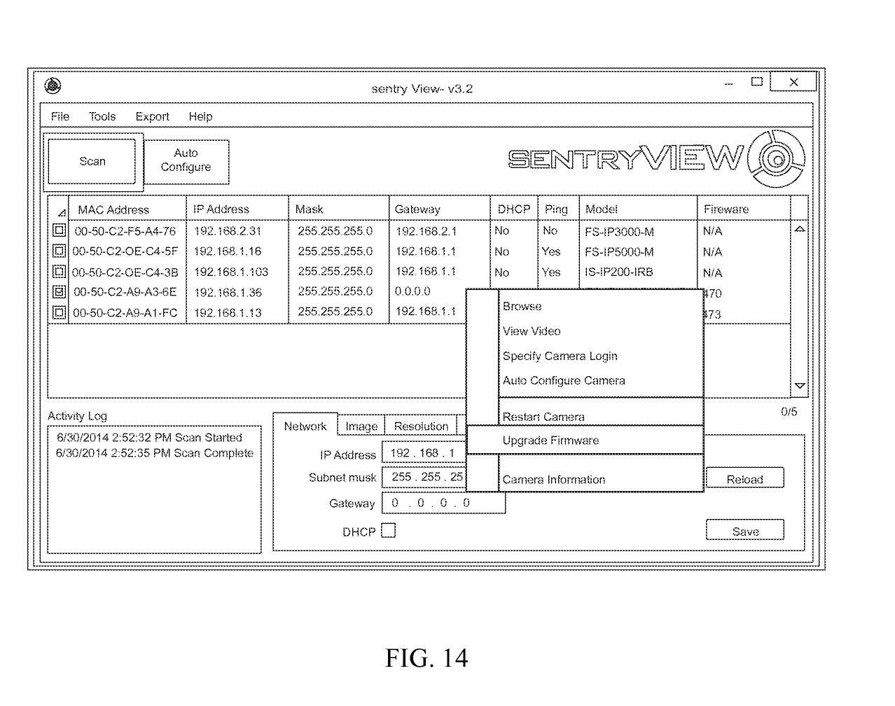

The sub-process for batch broadcast firmware uploads sends a firmware file 53 chosen by the user to the specific camera 31 or the group of cameras, as defined by the user. In reference to FIG. 5, to upload the firmware file 53 to the specific camera 31 or the group of cameras, the user first makes a camera selection 23 for the specific camera 31 or the group of cameras through the graphical user interface 20, as depicted in FIG. 14. The user then makes a firmware file selection 52 for the firmware file 53. Upon receiving the camera selection 23 and the firmware file selection 52, the software program 2 uploads the firmware file 53 to the specific camera 31 or the group of cameras using the specified communication protocol (e.g. TFTP or HTTP).

In the preferred embodiment of the present invention, the camera selection 23 is made by right-clicking on the camera item 22 in the camera table 21 for the specific camera 31 as shown in FIG. 14, or by selecting multiple cameras via check box for the group of cameras. A menu for the specific camera 31 or the group of cameras is then opened and displayed through the graphical user interface 20. The user can then select the “upgrade firmware” option, which initiates the firmware file selection 52. The user then makes the firmware file selection 52 and the software program 2 uploads the firmware file 53 corresponding to the firmware file selection 52 to the specific camera 31 or to the group of cameras.

The batch broadcast firmware uploads sub-process allows the user to browse for the firmware file 53, which may be stored locally on the host device, on the network 1, or on another network 1. When the firmware file 53 is selected and the user confirms, the firmware file 53 will be uploaded to the specific camera 31 or the group of cameras, and the software program 2 will report the progress and success or failure of the upload through the graphical user interface 20. Depending on camera type, the batch broadcast firmware uploads sub-process takes approximately one minute per camera. And in the case of multiple camera receiving firmware upgrades, the batch broadcast firmware uploads sub-process removes twenty to thirty seconds worth of extra clicks for each individual upgrade.

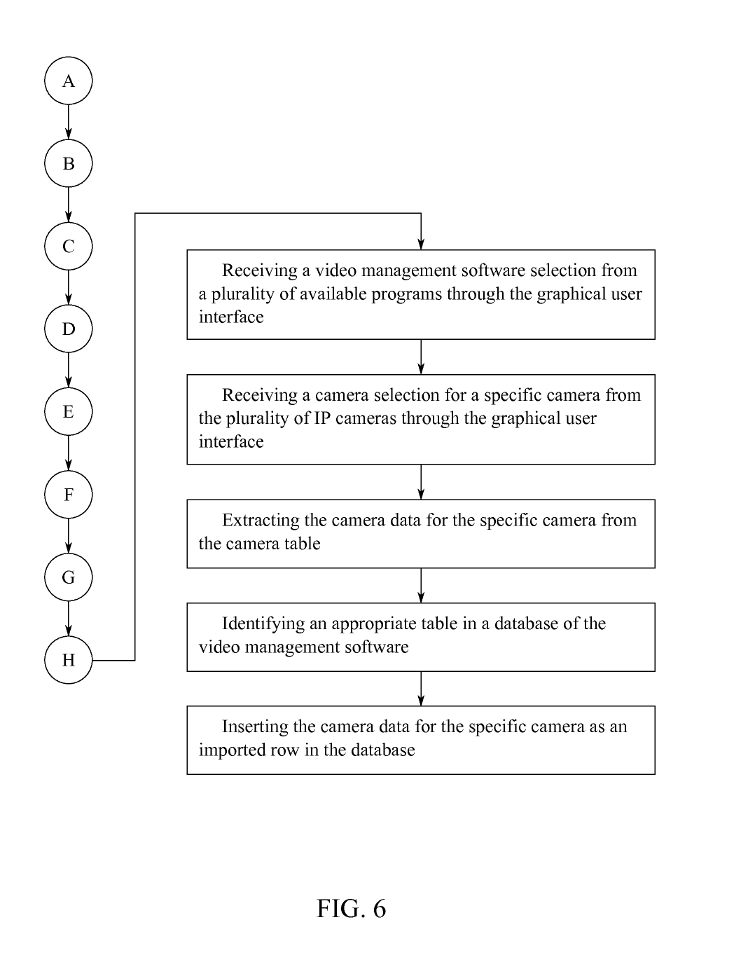

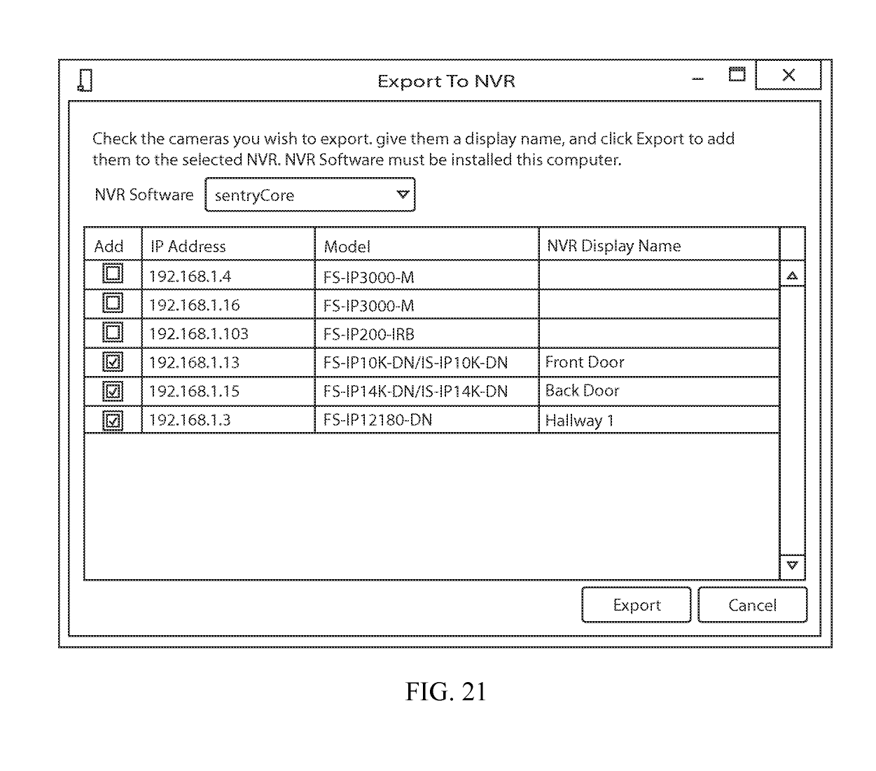

The sub-process to export cameras to third-party VMS allows for a degree of third-party compatibility. Again, the invention is a configuration tool, intended to drastically reduce the amount of time spent configuring cameras on a network 1, including adding the cameras in as network 1 devices into VMS programs. The sub-process to export cameras to third-party VMS allows the user to export the camera data 30 for the specific camera 31 or the group of cameras, as selected by the user, to a VMS 6. In reference to FIG. 6, to export the camera data 30 for the specific camera 31 or the group of cameras, the user first makes a VMS selection 54 from a plurality of available programs 55 through the graphical user interface 20. The VMS selection 54 corresponds to the VMS 6 to which the camera data 30 will be exported. The user then submits the camera selection 23 for the specific camera 31 or the group of cameras through the graphical user interface 20, as depicted in FIG. 21. Upon receiving the VMS selection 54 and the camera selection 23, the software program 2 exports the camera data 30 for the specific camera 31 or the group of cameras to the VMS 6 corresponding to the VMS selection 54, wherein the camera data 30 is appropriately converted to the file format of the VMS 6.

In reference to FIG. 6, the camera data 30 for the specific camera 31 or the group of cameras is exported to the VMS 6 by first extracting the camera data 30 from the camera table 21. The software program 2 then identifies an appropriate table 60 in a database 61 of the VMS 6. Once the appropriate table 60 is identified, the software program 2 inserts the camera data 30 for the specific camera 31 or the group of cameras as an imported row 62 in the database 61 of the VMS 6.

In reference to FIG. 21, in the preferred embodiment of the present invention, the user can make the VMS selection 54 from a list of available software choices from a dropdown menu of VMS 6. The camera selection 23 is then made by checking off the camera models the user would like to export. Alternatively, the user can enter a camera model name in an open field. The software program 2 then retrieves the camera data 30 for the specific camera 31 or the group of cameras, and then through the use of Structured Query Language (SQL), inserts the camera data 30 into the appropriate table 60 as an imported row 62 in the SQL database 61.

The export to third-party VMS sub-process can take anywhere from twenty seconds to a minute depending on the number of cameras that need to be individually named. This saves time, as convention manual entry of camera IP addresses in the VMS 6 could take up to at least a minute per camera. The actual export of the camera data 30 and inserting of the camera data 30 into the SQL database 61 takes only two to three seconds.

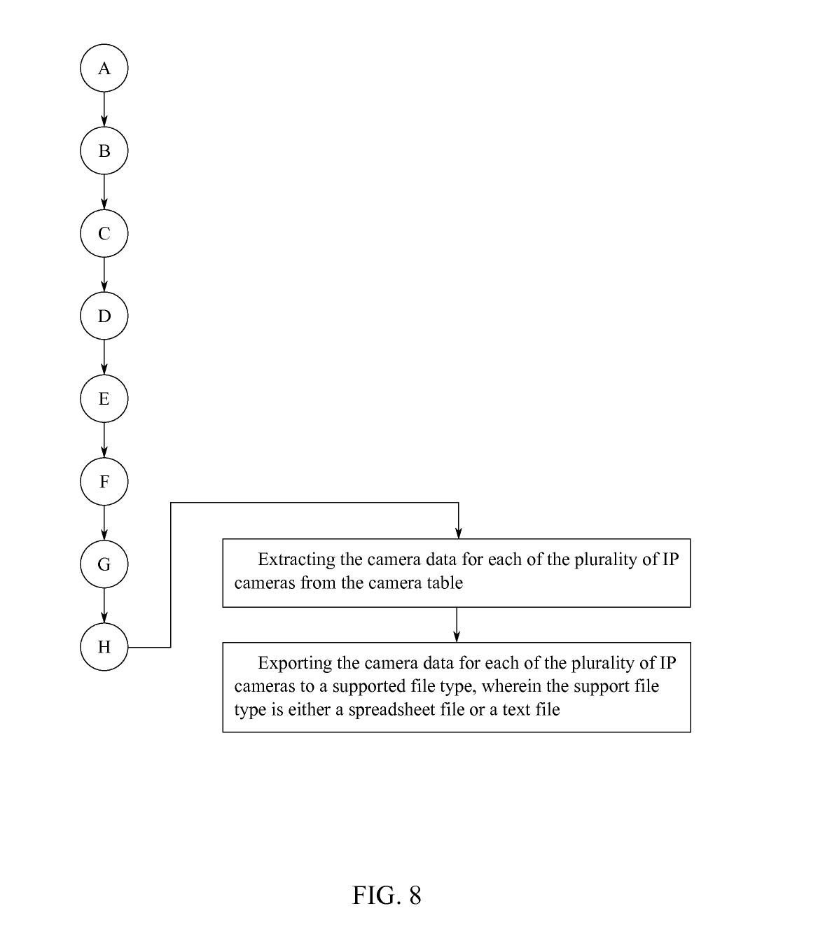

Both the sub-process to export cameras to a spreadsheet application and the sub-process to export cameras to a text file 82 are similar to the sub-process for exporting to third-party VMS. In reference to FIG. 8, in each case the camera data 30 for each of the plurality of IP cameras 3 is extracted from the camera table 21 and exported to a supported file type 80. For the sub-process to export cameras to a spreadsheet application, the supported file type 80 is a spreadsheet file 81, while for the sub-process to export cameras to a text file 82, the supported file type 80 is a text file 82.

For the sub-process to export cameras to a spreadsheet application, the spreadsheet file 81 is generated with columns for the Mac address, IP address, mask, gateway, DHCP, model, firmware, username, and password listed for each of the plurality of IP cameras 3 on the network 1 found in the latest scan. The spreadsheet file 81 is initially blank aside from the column titles that correspond to the column titles for each of the plurality of columns 212 in the camera table 21. When the user chooses to export camera settings, the camera data 30 for each of the plurality of IP cameras 3 is first extracted from the camera table 21 and then exported to the spreadsheet file 81, wherein the camera data 30 for each of the plurality of IP cameras 3 is inserted into the corresponding blank cells of the spreadsheet file 81.

For the sub-process to export cameras to a text file 82, the text file 82 is initially blank. When the user chooses to export camera settings, the camera data 30 for each of the plurality of IP cameras 3 is first extracted from the camera table 21 and then exported to the text file 82, wherein the camera data 30 for each of the plurality of IP cameras 3 is appropriately formatted throughout the text file 82. More specifically, the camera data 30 for each of the plurality of IP cameras 3 is inserted in a separate row, while the camera data 30 is aligned under headers corresponding to categories within the camera data 30. For example, headers would be included to separate the Mac address, IP address, mask, gateway, DHCP, model, firmware, username, and password listed for each of the plurality of IP cameras 3.

The sub-process to export cameras to a spreadsheet application and the sub-process to export cameras to a text file 82 are important for allowing the user to quickly keep track of each of the plurality of IP cameras 3 that are on the network 1 in a clear, organized way. The sub-process to export cameras to a spreadsheet application and the sub-process to export cameras to a text file 82 are much simpler than manually entering all of the camera data 30 for each of the plurality of IP cameras 3 in a spreadsheet, or even writing everything down. The sub-process to export cameras to a spreadsheet application and the sub-process to export cameras to a text file 82 take one to two seconds, compared to upwards of five to ten minutes for manual data entry depending on the number of cameras.

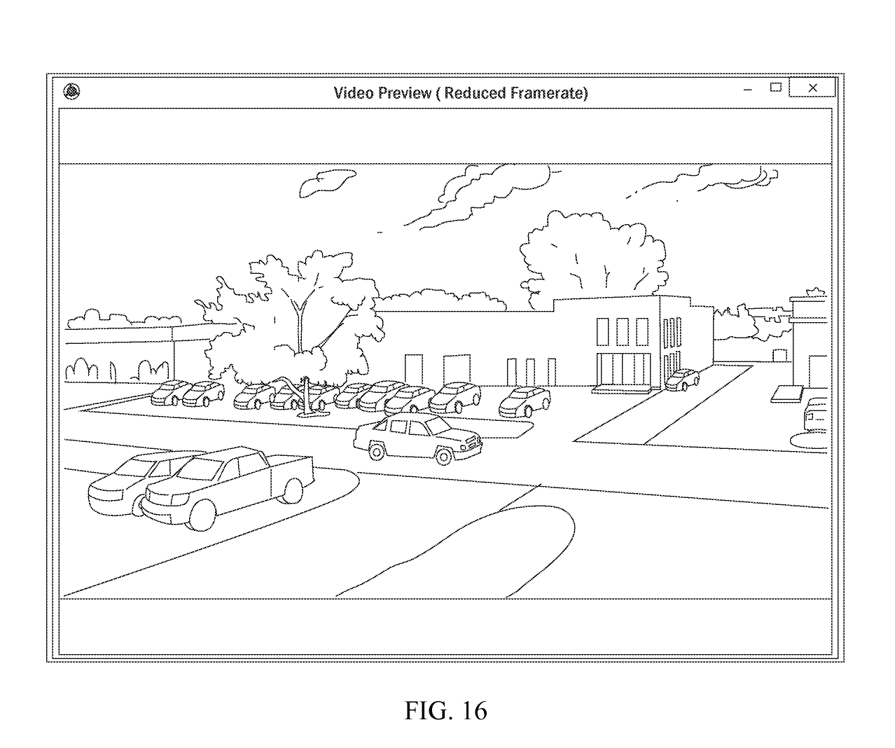

The sub-process for previewing a camera feed allows the user to view the live feed stream 26 of a specific camera 31 from the plurality of cameras through a second graphical user interface 25. In reference to FIG. 16, the second graphical user interface 25 is a mini-pane which displays the live feed stream 26 of the specific camera 31 and allows the user to interact with the specific camera 31 to various degrees by manipulating viewing functions of the specific camera 31. The second graphical user interface 25 supports digital pan-tilt-zoom controls using the mouse buttons and scroll wheel. The user can zoom in and out by scrolling the mouse wheel, and drag the image by holding down the left mouse button and dragging. The user can leave the second graphical user interface 25 open at all times, even when clicking between cameras in the graphical user interface 20 with the camera table 21.

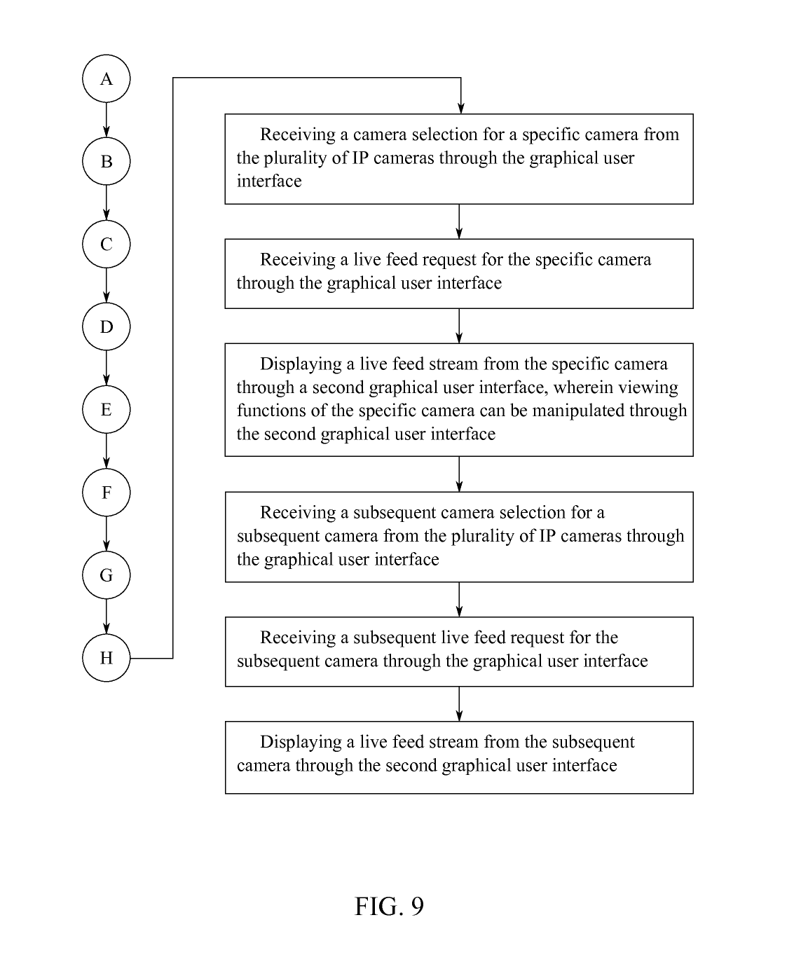

In reference to FIG. 9, to display the live stream feed of the specific camera 31, the user first makes a camera selection 23 for the specific camera 31 through the graphical user interface 20. The user then makes a live feed request 56 for the specific camera 31 through the graphical user interface 20. Upon receiving the camera selection 23 and the live feed request 56 for the specific camera 31, the software program 2 opens the second graphical user interface 25 (new program window), wherein the live feed stream 26 for the specific camera 31 is displayed. The second graphical user interface 25 will automatically populate with the live feed stream 26 in two seconds.

In the preferred embodiment of the present invention, the user cannot open more than one preview window (i.e. the user can only open the graphical user interface 20 and the second graphical user interface 25). However, the user can switch from the live feed stream 26 of the specific camera 31 to the live feed stream 26 of a subsequent camera 32 from the plurality of IP cameras 3. In this way, the second graphical user interface 25 can always be populated with the live feed stream 26 for the specific camera 31 with which the user is currently working.

The user can switch to the live stream feed of the subsequent camera 32 within the second graphical user interface 25 as desired. Similar to the specific camera 31 and in reference to FIG. 9, to display the live stream feed of the subsequent camera 32, the user first makes a subsequent camera 32 selection 24 for the subsequent camera 32 through the graphical user interface 20. The user then makes a subsequent live feed request 57 for the subsequent camera 32 through the graphical user interface 20. Upon receiving the subsequent camera 32 selection 24 and the subsequent live feed request 57 for the subsequent camera 32, the software program 2 switches the live feed stream 26 for the specific camera 31 to the live feed stream 26 of the subsequent camera 32 in the second graphical user interface 25. The second graphical user interface 25 will automatically populate with the subsequent live feed stream 26 in two seconds.

In the preferred embodiment of the present invention, the camera selection 23 and the subsequent camera 32 selection 24 are made by right-clicking on the camera item 22 in the camera table 21 for the specific camera 31 or the subsequent camera 32, respectively. A menu for the specific camera 31 or the subsequent camera 32 is then opened and displayed through the graphical user interface 20. The user can then select the “view video” option, which initiates the display of the live stream feed for either the specific camera 31 or the subsequent camera 32 within the second graphical user interface 25. Additionally, in the preferred embodiment of the present invention, the live feed stream 26 is a Motion Joint Photographic Experts Group (MJPEG) format. Notably, the MJPEG format has a reduced frame rate so the live feed stream 26 is not using the full bandwidth.

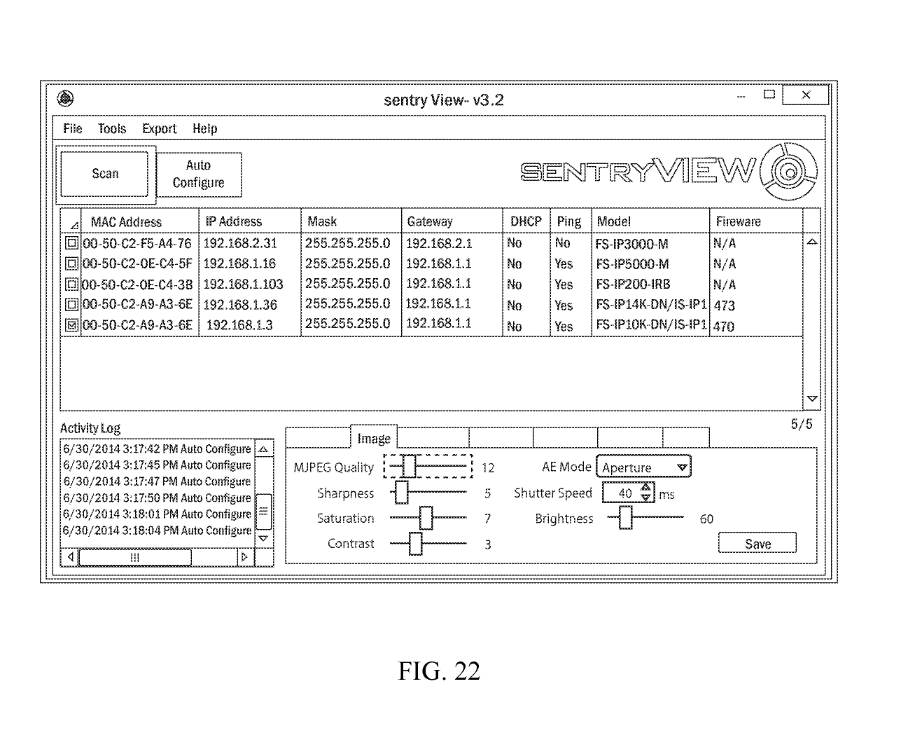

The sub-process for controlling camera image settings 70 allows the user to manipulate image settings 70 for each of the plurality of IP cameras 3 through the graphical user interface 20, as depicted in FIG. 22. The image settings 70 can include, but are not limited to, the broadcast image, frame rate, and bit rate control settings for each of the plurality of IP cameras 3. Through the graphical user interface 20, via the camera's CGI commands, the user can manually set image quality settings via slider bars, drop down menus, and numerical text fields for the specific camera 31 and send the image settings 70 to the specific camera 31.

In reference to FIG. 22, there are also several tabs at the bottom of the graphical user interface 20 that can be used in conjunction with the second graphical user interface 25 for easier use. For example, the user can click on the camera item 22 for the specific camera 31 through the graphical user interface 20, click an image tab, and adjust a sharpness value with a slider bar indicating the current value and click a save button to send the information to the specific camera 31. The image settings 70 may include quality, sharpness, saturation, contrast, brightness, image flip/rotation, and exposure settings. In combination with the second graphical user interface 25 being open, the user can see the adjustments to the image of the specific camera 31 occur in real time, while each of the image settings 70 is automatically saved to the specific camera 31. This prevents the user from having to open each individual camera web page 90, configure settings, save, close, and open up a new page with the next camera's IP address. This process could take several minutes per camera, but can take less than thirty seconds per camera through the present invention.

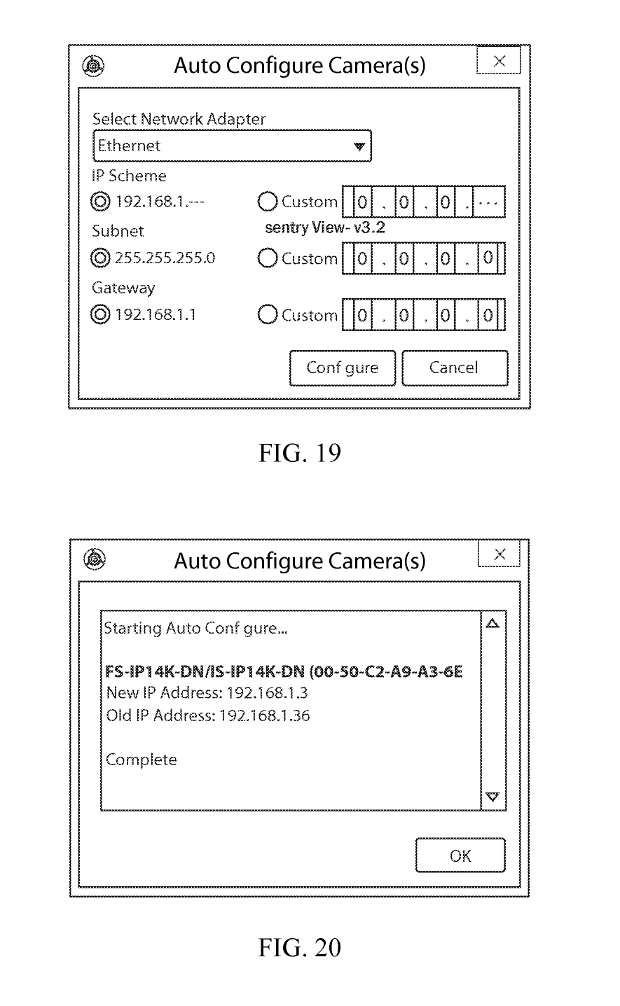

The sub-process for broadcast bandwidth management allows the user to manipulate various transmission settings 71 for each of the plurality of IP cameras 3 through the graphical user interface 20, as depicted in FIG. 19-20. The transmission settings 71 allows for the multicast array and configuration of both resolution and bit rate for simultaneous streams. Additionally, the transmission settings 71 allows the user to multicast IP addresses and ports and change a camera's available streams (between one and four available simultaneous streams), the specified resolution for each stream, and the specified bit rate for each stream through either drop down menus or numerical text boxes. For example, a user can click on the specific camera 31, click a resolution tab, and choose available codec (MJPEG or H.264) and resolution values to be sent to the specific camera 31 via CGI command. Similar to the image settings 70, the transmission settings 71 can save several minutes per camera because everything is done directly through the software program 2, instead of each individual camera web page 90.

The following provides examples of additional transmission settings 71 that can be controlled by the user. Through the graphical user interface 20, the user can change additional network 1 settings including Domain Name System (DNS), Transmission Control Protocol (TCP), Real Time Streaming Protocol (RTSP), and User Datagram Protocol (UDP) ports and timeout. The present invention can change the additional network 1 settings internally using CGI commands and the user-input data. All data is sent via the camera's specified CGI commands.

The sub-process for calibrating camera image allows the user to calibrate and configure cameras for one hundred eighty degree viewing. A series of IP cameras from the plurality of IP cameras 3 is arranged and used to view and display a one hundred eighty degree panoramic view, which is achieved by cropping and centering a fisheye image from each of the series of IP cameras. When each of the series of IP cameras is being configured for the first time, or the user has somehow changed a camera's orientation to an incorrect view, then the user can manually calibrate the image. A specific camera 31 is selected from the series of IP cameras, wherein the second graphical user interface 25 is opened, displaying the live feed stream 26 of the specific camera 31.

Once the live feed stream 26 for the specific camera 31 from the series of IP cameras is open, the user can click arrow buttons displayed through the second graphical user interface 25 to calibrate the image of the live feed stream 26 of the specific camera 31. Clicking each of the arrow buttons increases or decreases offset values vertically or horizontally, meaning the image of the live stream feed is shifted up and down or left and right in view. In the preferred embodiment of the present invention, the interface controls are the arrow buttons, however, alternate controls can be implemented in other embodiments of the present invention, such as click-and-drag features.

Numerical values are assigned for the offset values and for cropping the image of the live feed stream 26 of the specific image. Once the image for the live feed stream 26 of the specific camera 31 has been cropped and each of the offset values has been increased or decreased correctly, the software program 2 sends the numerical values to the specific camera 31 through CGI commands, wherein the numerical values are received by the specific camera 31 and permanently saved. The numerical values are never displayed to the user because it is easier to understand simple up, down, left, right buttons and view the corresponding display. Inputs through the up, down, left, right buttons are internally interpreted by the software program 2 as increasing or decreasing the offset view in the specified direction. In the preferred embodiment of the present invention, each input through one of the up, down, left, or right buttons offsets the image of the live feed stream 26 by sixteen pixels in the specified direction.

The sub-process for calibrating camera image allows the user to readily select the specific camera 31 from the series of IP cameras and quickly adjust and store parameters for the display of the live feed stream 26 for the specific camera 31. A manual process through the web interface of each of the series of IP cameras can take up to five minutes for each of the series of IP cameras. The sub-process for calibrating camera image streamlines the calibration process to no more than thirty seconds to one minute per camera.

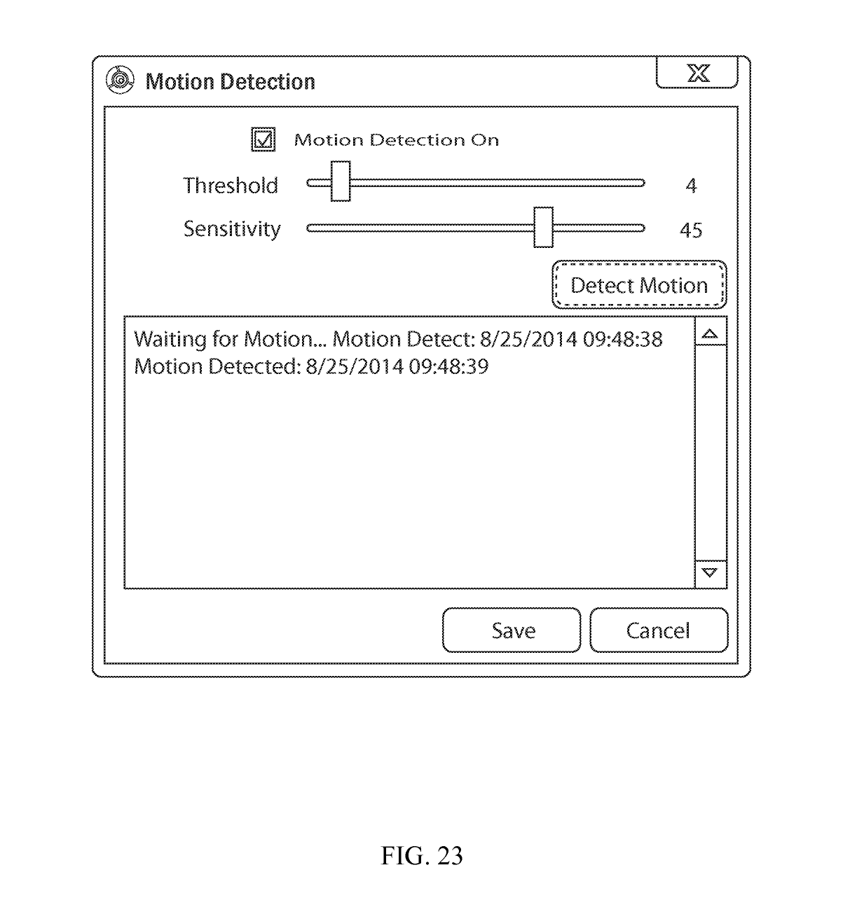

The sub-process for calibrating camera motion detection allows the user to enable motion detection settings for each of the plurality of IP cameras 3. The user can also test and adjust sensitivity levels of the current motion detection state of each of the plurality of IP cameras 3 through the calibrating camera motion detection sub-process. To calibrate motion detection settings of a specific camera 31, the user first makes a camera selection 23 for the specific camera 31 through the graphical user interface 20. The user then makes a motion detection calibration request for the specific camera 31 through the graphical user interface 20. In reference to FIG. 23, upon receiving the camera selection 23 and the motion detection calibration request for the specific camera 31, the software program 2 opens the second graphical user interface 25 (new program window), wherein the motion detection settings for the specific camera 31 is displayed.

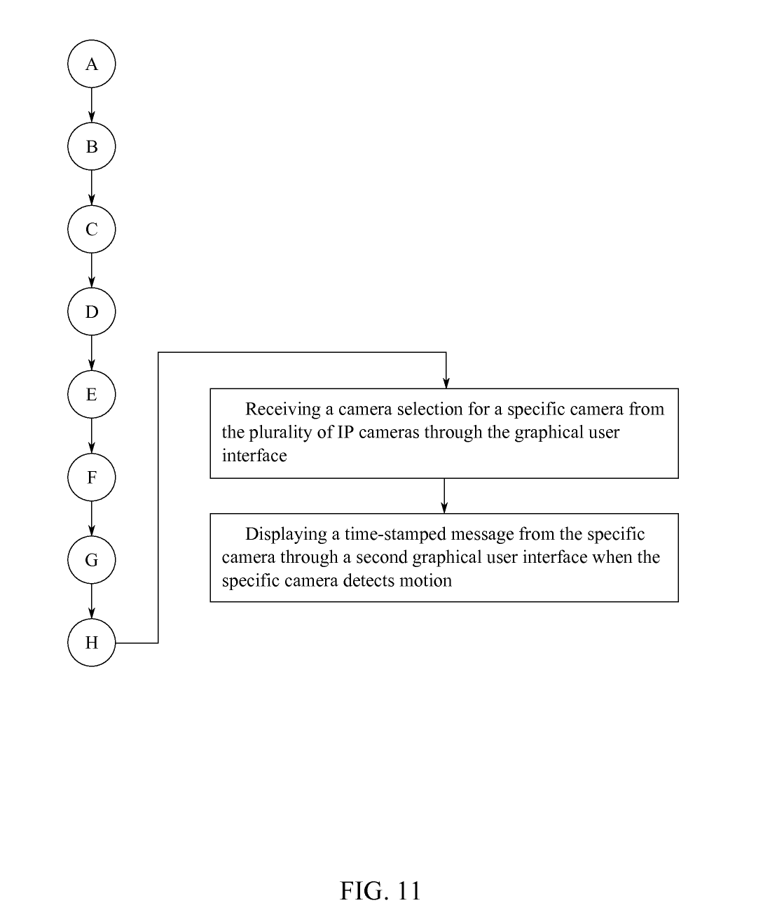

Through the motion detection window (the second graphical user interface 25), the user can enable a motion test for the specific camera 31. In reference to FIG. 11, for the motion test, the software program 2 will display a time-stamped message 72 from the specific camera 31 through the second graphical user interface 25 each time motion has been detected by the specific camera 31. The software program 2 connects to the specific camera 31 through the specified port or CGI command and waits for the specific camera 31 to return a response in the metadata that indicates motion is currently happening in view of the camera. Values for the threshold and sensitivity levels of the motion detection capabilities of the specific camera 31 are set within the motion detection settings for the specific camera 31. The threshold and sensitivity levels are adjusted in real time until the user is satisfied with the frequency in which the time-stamped message 72 for each recognized movement is reported by the specific camera 31.

While the sub-process for calibrating camera motion detection is underway, the second graphical user interface 25 will continue to display the time-stamped message 72 reported by the specific camera 31 each time the specific camera 31 detects motion. The time-stamped message 72 for each movement detected can be displayed in list format, or any other suitable display. Ideally, the sub-process for calibrating camera motion detection only takes up to thirty seconds per camera.

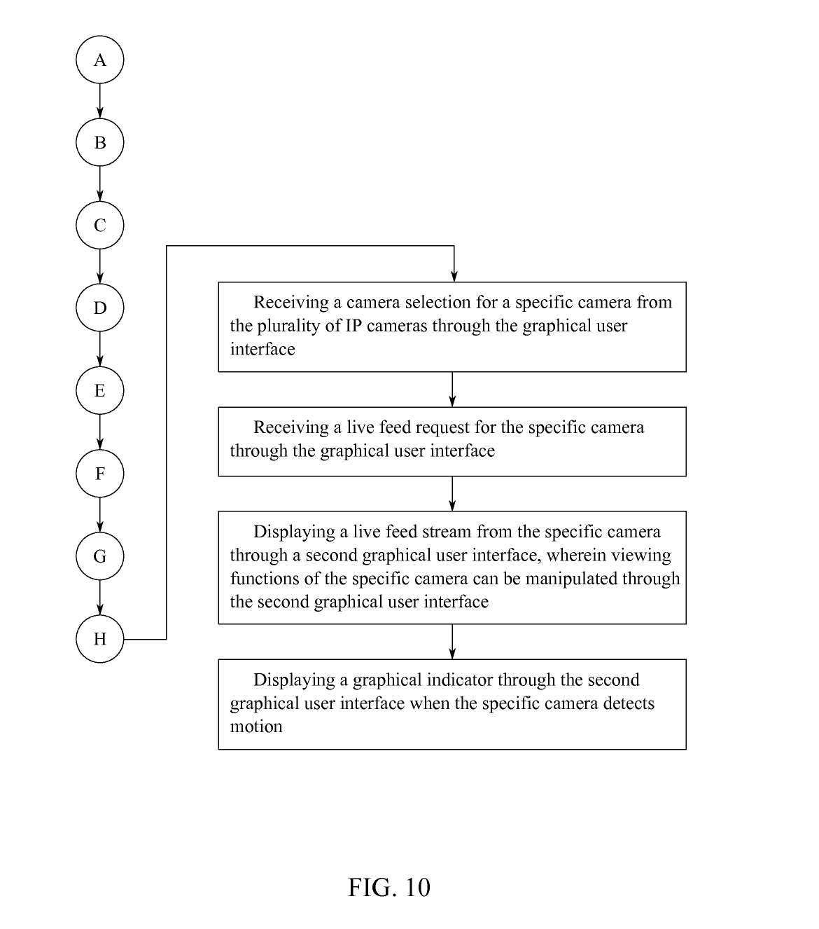

In an alternative embodiment of the present invention, the sub-process for calibrating camera motion detection provides a different interface and notification system for viewing the time-stamped message 72. Instead of the rolling time-stamp format, the software program 2 will provide a more visually interactive indicator of motion detection. In reference to FIG. 10, the live feed stream 26 for the specific camera 31 is displayed in the second graphical user interface 25, wherein a graphical indicator 27 is displayed as a top layer above the live feed stream 26. As motion is detected, the graphical indicator 27 visually depicts to the user that motion has been detected. The graphical indicator 27 can be a simple colored tint, or may include any number of other graphics to provide a visual indicator to the user. The use of the graphical indicator 27 is intended to make the sub-process for calibrating camera motion detection more eye-catching and a more effective means of drawing the attention of the user.

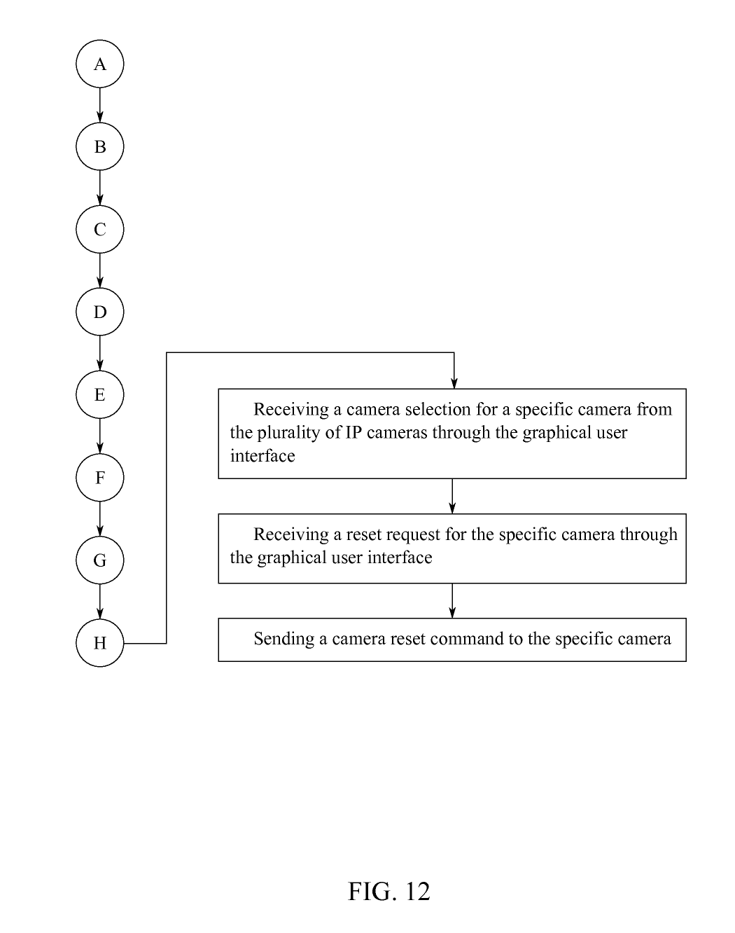

The final sub-process is the sub-process for returning cameras to default settings, which allows the user to restore each of the plurality of IP cameras 3 to the factory default settings. If the user is unsatisfied with the image settings 70, the network 1 settings, or any other settings of a camera, the user can utilize the sub-process for returning cameras to default settings to restart all of the settings. In reference to FIG. 12, to restart a specific camera 31 from the plurality of IP cameras 3, the user first makes a camera selection 23 for the specific camera 31 through the graphical user interface 20. The user then makes a reset request 58 for the specific camera 31 through the graphical user interface 20. Upon receiving the camera selection 23 and the reset request 58, the software program 2 sends a camera rest command 59 (CGI command) to the specific camera 31.

Before the software program 2 sends the camera rest command 59 to the specific camera 31, the software program 2 prompts the user with a warning that camera settings will be changed permanently and that the network 1 configuration may be altered. The user must then agree to proceed with sending the camera rest command 59 by indicating acceptance through the dialog box used to prompt the user. Once the camera rest command 59 is sent to the specific camera 31, the specific camera 31 may be required to restart, at which point the specific camera 31 will turn off and the online status 43 for the specific camera 31 will be designated as offline in the camera table 21. When the specific camera 31 turns back on, the factory default settings will be applied to the specific camera 31 and the specific camera 31 will respond the next time the software program 2 pings the plurality of IP cameras 3, wherein the online status 43 for the specific camera 31 will be designated as online in the camera table 21.

In the preferred embodiment of the present invention, the camera selection 23 is made by right-clicking on the camera item 22 in the camera table 21 for the specific camera 31. A menu for the specific camera 31 is then opened and displayed through the graphical user interface 20. The user can then select the “default settings” option, which initiates the reset request 58. The camera rest command 59 is then sent to the specific camera 31, wherein the specific camera 31 is restored to the factory default settings.

The following is intended to provide an overview of the present invention as previously discussed. During startup of the software program 2, the user is presented with the camera table 21 being a blank table with headings for fields such as the MAC address, IP address, etc. In reference to FIG. 1, the software program 2 then performs the network 1 scanning process, wherein the software program 2 sends out the specific packets 40 across the network 1. The software program 2 then receives the packet response 41 and the camera data 30 for each of the plurality of IP cameras 3 discovered on the network 1, wherein the camera data 30 for each of the plurality of IP cameras 3 is added to the camera table 21, as depicted in FIG. 13. Once each of the plurality of IP cameras 3 is discovered on the network 1, the camera timeout detection sub-process is used to monitor and record which of the plurality of IP cameras 3 is currently online. The timeout interval 42 can be set by the user in order to define the frequency with which the software program 2 pings the plurality of IP cameras 3.

When the network 1 scanning process is complete and the user sees all available cameras on the network 1, the user can perform the following actions on the plurality of IP cameras 3, either individually or in batch. The remainder of the sub-processes are largely independent of the aforementioned startup and network 1 scanning process. The following sub-processes can be run at any time, on any of the plurality of IP cameras 3 at the discretion of the user.

In reference to FIG. 2, the communication protocol sub-process, which handles multiple communication types, allows the user to choose between TFTP and HTTP communication types for sending requests. This allows fast-swapping and ensures continued system functionality in the event one communication type malfunctions.

In reference to FIG. 3 and FIG. 15, the camera browser web interface launching sub-process allows the user to access the web page 90 of any available camera quickly. Once prompted by the user, the camera browser web interface launching sub-process automatically launches the web browser 91 with the camera IP address already loaded into the browser address bar. This is faster than manually entering the information through the web browser 91.

In reference to FIG. 4 and FIG. 17-18, the remote restarting sub-process allows the user to avoid having to navigate into the web interface to find the correct button to restart the camera. The remote restarting sub-process also alleviates the user of the need to physically unplug the camera from the network 1.

In reference to FIG. 5 and FIG. 14, the batch broadcast firmware upload sub-process allows the user to update firmware on multiple cameras quickly.

In reference to FIG. 6 and FIG. 21, the exporting cameras to third-party VMS sub-process allows the user to quickly transfer camera information via SQL insert commands, automating the process.

In reference to FIG. 8, the exporting cameras to a spreadsheet application sub-process and the exporting cameras to a text file 82 sub-process allow the user to quickly transfer camera information a spreadsheet file 81 or a text file 82 respectively exporting cameras to a spreadsheet application sub-process.

In reference to FIG. 9 and FIG. 16, the sub-process for previewing a camera feed allows the user to view the live feed stream 26 of the camera with which the user is currently working.

In reference to FIG. 22, the sub-process for controlling camera image settings 70 allows the user to adjust the image settings 70 for each of the plurality of IP cameras 3.

In reference to FIG. 19-20, the sub-process for broadcast bandwidth management allows the user to adjust the transmission settings 71 for each of the plurality of IP cameras 3.

The sub-process for calibrating camera image allows the user to calibrate and configure cameras for one hundred eighty degree viewing by cropping and adjusting the offset values of the plurality of IP cameras 3.

In reference to FIG. 23, the sub-process for calibrating camera motion detection allows the user to adjust the motion detection settings of each of the plurality of IP cameras 3 in order to determine the ideal threshold for detecting and reporting motion.

In reference to FIG. 12, the sub-process for returning cameras to default settings allows the user to restore each of the plurality of cameras to the factory default settings.

Although the invention has been explained in relation to its preferred embodiment, it is to be understood that many other possible modifications and variations can be made without departing from the spirit and scope of the invention as hereinafter claimed.

What is claimed is:

1. A method for configuring and managing cameras in a network by executing computer-executable instructions stored on a non-transitory computer-readable medium, the method comprises the steps of:
providing a graphical user interface for displaying and managing a plurality of Internet Protocol (IP) cameras operated across a network;
scanning the network by sending specific packets to the plurality of IP cameras across the network;
receiving a packet response and camera data from each of the plurality of IP cameras;
adding the camera data for each of the plurality of IP cameras to a camera table as a camera item;
displaying the camera table through the graphical user interface, wherein the camera item for each of the plurality of IP cameras is selectable;
pinging the plurality of IP cameras as designated by a timeout interval in order to determine an online status for each of the plurality of IP cameras;
recording the online status of each of the plurality of IP cameras; and
displaying the online status of each of the plurality of IP cameras in the camera table.

2. The method for configuring and managing cameras in a network by executing computer-executable instructions stored on a non-transitory computer-readable medium, the method as claimed in claim 1 further comprises the steps of:
providing a first communication protocol and a second communication protocol for establishing connection with the plurality of IP cameras; and
switching between the first communication protocol and the second communication protocol, wherein either the first communication protocol or the second communication protocol is unsuitable.

3. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface;
receiving a web interface access request for the specific camera through the graphical user interface; and
retrieving a web page for the specific camera through a web browser.

4. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface;
receiving a restart request for the specific camera through the graphical user interface; and
sending a restart command to the specific camera.

5. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface;
receiving a firmware file selection through the graphical user interface for the specific camera; and
uploading a firmware file corresponding to the firmware file selection to the specific camera.

6. The method for configuring and managing cameras in a network by executing computer-executable instructions stored on a non-transitory computer-readable medium, the method as claimed in claim 1 further comprises the steps of:
receiving a video management software selection through the graphical user interface;
receiving a camera selection for a specific camera from the plurality of IP cameras through the graphical user interface; and
exporting the camera data for the specific camera to a video management software corresponding to the video management software selection.

7. The method for configuring and managing cameras in a network by executing computer-executable instructions stored on a non-transitory computer-readable medium, the method as claimed in claim 6 further comprises the steps of:
extracting the camera data for the specific camera from the camera table;
identifying an appropriate table in a database of the video management software; and
inserting the camera data for the specific camera as an imported row in the database.

8. The method for configuring and managing cameras in a network by executing computer-executable instructions stored on a non-transitory computer-readable medium, the method as claimed in claim 6, wherein the video management software selection is chosen from a plurality of available programs through the graphical user interface.

9. The method for configuring and managing cameras in a network by executing computer-executable instructions stored on a non-transitory computer-readable medium, the method as claimed in claim 1 further comprises the steps of:
assigning the camera item for each of the plurality of IP cameras to a specific row in the camera table; and
organizing the camera data for each of the plurality of IP cameras into a plurality of columns in the camera table.

10. The method for configuring and managing cameras in a network by executing computer-executable instructions stored on a non-transitory computer-readable medium, the method as claimed in claim 1 further comprises the steps of:
extracting the camera data for each of the plurality of IP cameras from the camera table; and
exporting the camera data for each of the plurality of IP cameras to a supported file type.

11. The method for configuring and managing cameras in a network by executing computer-executable instructions stored on a non-transitory computer-readable medium, the method as claimed in claim 10, wherein the supported file type is a spreadsheet file.

12. The method for configuring and managing cameras in a network by executing computer-executable instructions stored on a non-transitory computer-readable medium, the method as claimed in claim 10, wherein the supported file type is a text file.

13. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface;
receiving a live feed request for the specific camera through the graphical user interface; and
displaying a live feed stream from the specific camera through a second graphical user interface.

14. The method for configuring and managing cameras in a network by executing computer-executable instructions stored on a non-transitory computer-readable medium, the method as claimed in claim 13, wherein viewing functions of the specific camera can be manipulated through the second graphical user interface.

15. The method for configuring and managing cameras in a network by executing computer-executable instructions stored on a non-transitory computer-readable medium, the method as claimed in claim 13 further comprises the steps of:
receiving a subsequent camera selection for a subsequent camera from the plurality of IP cameras through the graphical user interface;
receiving a subsequent live feed request for the subsequent camera through the graphical user interface; and
displaying a live feed stream from the subsequent camera through the second graphical user interface in place of the live feed stream from the specific camera.

16. The method for configuring and managing cameras in a network by executing computer-executable instructions stored on a non-transitory computer-readable medium, the method as claimed in claim 13 further comprises the steps of:
displaying a graphical indicator through the second graphical user interface when the specific camera detects motion.

17. The method for configuring and managing cameras in a network by executing computer-executable instructions stored on a non-transitory computer-readable medium, the method as claimed in claim 1, wherein image settings for each of the plurality of IP cameras can be manipulated through the graphical user interface.

18. The method for configuring and managing cameras in a network by executing computer-executable instructions stored on a non-transitory computer-readable medium, the method as claimed in claim 1, wherein transmission settings for each of the plurality of IP cameras can be manipulated through the graphical user interface.

19. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface; and
displaying a time-stamped message from the specific camera through a second graphical user interface when the specific camera detects motion.

20. The method for configuring and managing cameras in a network by executing computer-executable instructions stored on a non-transitory computer-readable medium, the method as claimed in claim 1 further comprises the steps of:
receiving a camera selection for a specific camera from the plurality of IP cameras through the graphical user interface;
receiving a reset request for the specific camera through the graphical user interface; and
sending a camera reset command to the specific camera.
